(19) United States
(12) Patent Application Publication
(10) Pub. No.: US 2013/0185087 A1
(43) Pub. Date: Jul. 18, 2013

(54) MEDICAL HISTORY DATABASE

(71) Applicant: RICHARD MERKIN, Marina Del Rey, CA (US)

(72) Inventor: RICHARD MERKIN, Marina Del Rey, CA (US)

(21) Appl. No.: 13/351,364

(22) Filed: Jan. 17, 2012

(51) Int. Cl. G06Q 99/00; G06F 17/30

(52) U.S. Cl. 705/1.1; 707/736; 707/E17.014

(57) ABSTRACT

Methods and systems for storing information-complete medical records and making these information-complete medical records accessible to medical researchers. The methods may include obtaining medical records donated by deceased patients, converting the medical records into an electronic format, storing the electronic medical records in a database, making at least one piece of data contained with the medical records electronically searchable, and electronically transmitting the data to a user of the database. Systems may include a processor programmed with a server application configured to store electronic medical records data in a searchable format and to transmit the data to a user of the system.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Field of the Invention

The present invention relates generally to systems and methods of storing information complete patient medical records and providing medical researchers access to the records. In particular, the invention relates to systems and methods for allowing a patient to donate their medical records to a medical record database upon their death, wherein the medical records are not anonomyzed thereby preserving the richness of the data, and allowing medical researchers access to the database in a searchable manner.

2. Description of Related Art

Typically, patient medical records are subject to strenuous privacy protection, in order to protect the patient's confidentiality. While in a normal situation this is beneficial for all involved, it presents a difficulty to medical researchers who are in need of large amounts of data concerning various medical conditions and patient histories. Ideally, medical researchers would have access to a large amount of medical records for research purposes and that those medical records contain as much information about the patients and their medical histories as possible.

Currently, both of these areas are lacking. While there has been a significant progress in matching patients with clinical trials, for example. U.S. Pat. Nos. 7,483,838 and 7,904,313 and U.S. Patent Application Publication Nos. 2002/0002474 and 2010/0250285, this typically involves, at least in part, the patient entering information and/or seeking out a clinical trial to participate in. As such, while interest and accessibility in participating in clinical trials has increased, it is still a relatively small population of patients, and their medical records, that are available through these processes for medical researchers to examine.

Similarly, past attempts at providing data regarding large populations of patients have been less than ideal for medical research purposes. In particular, they have typically focused on the cost of medical services and their resulting success, or lack thereof, and/or they must anonomyze the data in order to protect patient confidentiality as this data was obtained without the permission and consent of the patient. By anonomyzing the data in this fashion, the richness of the data for medical research purposes is severely compromised.

Accordingly, there is a need in the art for a database containing medical records from a relatively large patient population having diverse backgrounds and medical histories for medical research purposes wherein the medical records have not been anonomyzed, thereby compromising much of their usefulness for future research purposes.

### BRIEF SUMMARY

One embodiment of the present invention contemplates a method of storing information-complete medical records and making those information-complete medical records accessible to medical researchers. In particular, the method includes the steps of obtaining medical records from at least one patient, converting the obtained medical records into an electronic format, storing the electronic medical records in a database contained on a non-transitory computer-readable medium, making at least one piece of data contained with the medical records electronically searchable within the database, and electronically transmitting the data to a user of the database.

The medical records may be obtained from a deceased patient. More specifically, the deceased patient may have decided to donate his or her medical records upon his or her death. The medical records may be obtained in either paper or electronic formats. If obtained in paper format, these medical records may be manually converted to electronic format by human input and/or may be scanned such that the data contained within the medical records are converted by optical character recognition software into the proper electronic format. If the conversion step is performed by human input, those performing the conversion may be acting in a volunteer capacity.

Notably, it is envisioned that potentially identifying data about the patient need not be removed from the medical records within the database, such that this data may be utilized by the medical researchers ultimately obtaining the data. Examples of such potentially identifying data that may be contained in the database and useful to medical researchers include, but are not limited to, geographic data, ethnicity data, social status data, and age.

It is envisioned that the methods of the present invention may be operated by a non-profit organization. In this case, the data may be electronically transmitted to a non-profit user of the database for no cost. Alternatively, or additionally, the data may be electronically transmitted to a for-profit user of the database for a fee.

Another embodiment of the present invention envisions a computer system for storing and accessing information-complete medical records. This computer system includes at least one processor programmed with at least a server application configured to store data contained within at least one patient's electronic medical records in an electronically searchable format and to electronically transmit the data to a user of the system. The server application itself is embodied on a non-transitory computer-readable medium.

The data may be stored within a medical record database. Furthermore, the data may have originated from paper and/or electronic medical records. These medical records may be obtained and entered into the system after the patient's death. In particular, the medical records may be donated by the patient for entry into the system.

The data may be electronically transmitted to the user of the system through an interface comprising an HTML-encoded web page. The stored and transmitted data may include potentially identifying information concerning the patient. Examples of this potentially identifying information include, but are not limited to, geographic data, ethnicity data, social status data, and age.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a flowchart exemplifying a method of the present invention for operating a medical records database.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

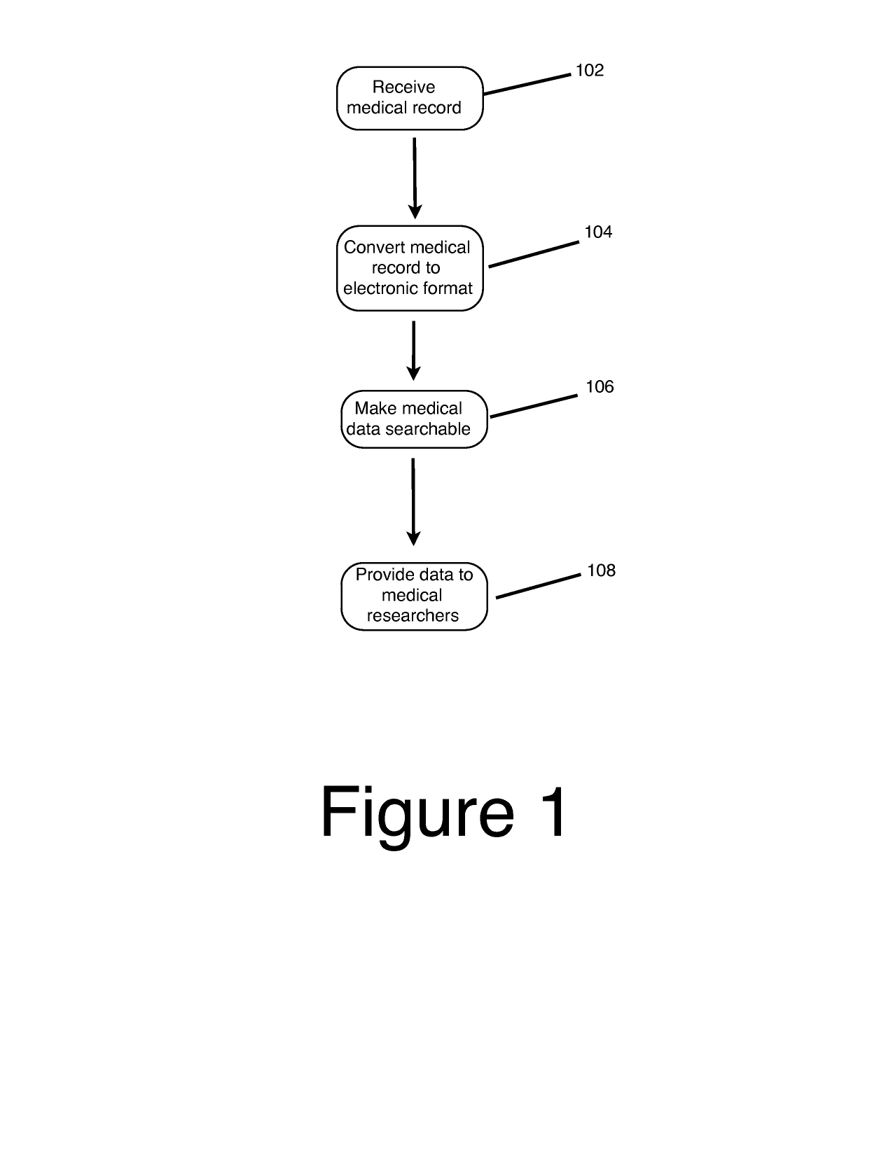

A system and method for storing electronic medical records and providing access to the medical records is described with reference to FIG. 1. In a first step 102, patient medical records are obtained by a medical research database provider. Although these medical records may be obtained in numerous ways, it is particularly envisioned that the patient will choose to donate the entirety of their medical records to the database provider upon their death. One aspect of the present invention may include public outreach efforts in order to educate patients as to why they should donate their medical records. In particular, potential donors would need to be informed that the societal benefits of donation outweigh any potential risks or fears they may have about disclosing such information. Part of these fears may be overcome by limiting the donation until after the patient's death, so that any potential release of the information contained within their medical records would not have any effect on their life. Additionally, it would be emphasized that the benefits to society at large, as well as the patient's own children, grandchildren, etc. may be benefited from the knowledge obtained by accessing a large pool of medical records. As such, it is envisioned that medical record donations will become commonplace, similar to organ donation currently. A remaining concern for some potential donors, however, may be details regarding genetic diseases, the information of which could potentially used against their progeny. Potential methods for addressing this concern include limiting the use of the database by insurance (medical and/or life) companies and/or removing genetic disease information from the database. However, as this information may be pertinent to medical researchers, limiting insurance company access to the information may be the best way to proceed.

Accordingly, donation of one's medical records will allow for a large database of medical records from patients with diverse backgrounds and histories covering widespread portions of geography, ethnicity, social status, age, health status, and the like. While the database may include cost and claim information, that is not the intended focus of the database. The medical records may be obtained in hard copy paper records and/or as electronic medical records (EMR) as is known within the art.

After receiving the medical records, whether in paper or electronic format, they are then converted in step 104 to an electronic format suitable for use with the database of the present invention. In particular, paper medical records must be wholly converted to an electronic format and even electronic-based records may not all be formatted similarly or use the same software. This conversion step may be labor intensive in that the paper records would need to be manually entered and dissimilar electronic record formats would need to be converted to a unified electronic format. While this step may be performed by humans, it would be advantageous to utilize, among other things, OCR (optical character recognition) software to scan and input paper records into the proper format and use software conversion techniques to convert dissimilar electronic records into a unified format for use with the database of the present invention. When human labor is required for this entry and conversion process, the database provider may hire employees to perform the function and/or “crowdsource” the conversion, that is volunteers may be recruited to perform the conversion step as a humanitarian task, since the results will be an improved medical research database that may be used for the treatment and/or prevention of medical conditions. While paper medical records may be utilized by the present invention, it is preferable that the patient's medical records initially be obtained in electronic format, as paper records would need to be transported to the medical database provider, stored until the conversion process has occurred, and then ultimately destroyed after the conversion. In contrast, electronic medical records could simply be entered into the database, or at the most converted to a format usable by the database.

Next, in step 106, the data contained within the medical records are made searchable so that medical researchers interested in particular data points may readily obtain the relevant records for their research purposes. In particular, all data points contained within the medical records may be entered into specific designated categories within the database for easy searching. Furthermore, since these medical records have been obtained as donations, in their entirety, from deceased patients they will not need to be anonomyzed, i.e., relevant data points, including but not limited to, geography, ethnicity, social status, age, and the like will not need to be stripped out of the records to protect patient anonymity. This results in a much more useful database for medical research purposes, where this information may be helpful or even critical for particular research areas. Since the usefulness of the medical records database of the present invention requires that the medical records contain as much pertinent information as possible, which obviously reduces the anonymity of the data, necessary steps known within the art would be taken to maintain the security and integrity of the database from unauthorized access.

Finally, in step 108, medical researchers are provided access to the medical record data contained within the database of the present invention. While it is envisioned that the medical record database provider of the present invention would be a non-profit organization, access to the data contained within the database may be provided to both non-profit researchers as well as for-profit research groups. Furthermore, it is envisioned that non-profit researchers may access the database for free, while for-profit research groups would pay for the access to cover the costs of establishing, running, and maintaining the database. Along those lines, it is envisioned that the operational costs of the medical records database of the present invention would be covered by charitable donations and/or the access fees paid by for-profit research companies.

The above description is given by way of example, and not limitation. Given the above disclosure, one skilled in the art could devise variations that are within the scope and spirit of the invention disclosed herein, including various ways of obtaining, formatting, and providing access to the data contained within the medical records. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of storing information-complete medical records and making said information-complete medical records accessible to medical researchers, said method comprising:
obtaining medical records from at least one patient;
converting the obtained medical records into an electronic format;
storing the electronic medical records in a database contained on a non-transitory computer-readable medium;
making at least one piece of data contained with the medical records electronically searchable within the database; and
electronically transmitting the data to a user of the database.

2. The method of claim 1 wherein the medical records are obtained from at least one deceased patient.

3. The method of claim 2 wherein the medical records were donated by the deceased patient.

4. The method of claim 1 wherein the medical records are in paper format.

5. The method of claim 1 wherein the medical records are in an electronic format.

6. The method of claim 4 wherein the medical records are manually converted to electronic format.

7. The method of claim 4 wherein the medical records are scanned and converted by optical character recognition software.

8. The method of claim 1 wherein potentially identifying data about the patient is not removed from the medical records within the database.

9. The method of claim 8 wherein the data contained within the database includes at least one potentially identifying field selected from the group consisting of geographic data, ethnicity data, social status data, and age.

10. The method of claim 1 wherein the medical records are converted to electronic format by volunteers.

11. The method of claim 1 wherein the data is electronically transmitted to a non-profit user of the database for no cost.

12. The method of claim 1 wherein the data is electronically transmitted to a for-profit user of the database for a fee.

13. A computer system for storing and accessing information-complete medical records comprising:
at least one processor programmed with at least a server application, wherein the server application is embodied on a non-transitory computer-readable medium;
wherein the server application is configured to store data contained within at least one patient's electronic medical records in an electronically searchable format and to electronically transmit the data to a user of the system.

14. The system of claim 13 wherein the data is stored within a medical record database.

15. The system of claim 13 wherein the data is transmitted to the user of the system through an interface comprising an HTML-encoded web page.

16. The system of claim 13 wherein the patient's electronic medical records are converted from a paper format.

17. The system of claim 13 wherein the patient's medical records are obtained after the patient's death.

18. The system of claim 17 wherein the patient's medical records were donated.

19. The system of claim 13 wherein the data includes potentially identifying information concerning the patient.

20. The system of claim 19 wherein the data includes at least one potentially identifying field selected from the group consisting of geographic data, ethnicity data, social status data, and age.
